(19) United States
(12) Patent Application Publication
(10) Pub. No.: US 2017/0346984 A1
(43) Pub. Date: Nov. 30, 2017

(54) SCANNER APPARATUS

(71) Applicant: TOSHIBA TEC KABUSHIKI KAISHA, Tokyo (JP)

(72) Inventor: Shinsuke YAJIMA, Mishima Shizuoka (JP)

(21) Appl. No.: 15/605,209

(22) Filed: May 25, 2017

(30) Foreign Application Priority Data
May 31, 2016 (JP) 2016-108077

(51) Int. Cl. H04N 1/028

(52) U.S. Cl. CPC H04N 1/02895; H04N 1/0288; H04N 2201/0081

(57) ABSTRACT

In accordance with an embodiment, a scanner apparatus includes an image pickup device and a light shielding member. The light shielding member is positioned to prevent generation of stray light reflected inside an image pickup window and entering the image pickup device and stray light reflected on a surface of a filter and entering the image pickup device, the stray light being generated due to illumination light of an illumination light source of the image pickup device.

### CROSS-REFERENCE TO RELATED APPLICATION

This application is based upon and claims the benefit of priority from the prior Japanese Patent Application No. 2016-108077, filed on May 31, 2016, the entire contents of which are incorporated herein by reference.

### FIELD

An embodiment described here generally relates to a scanner apparatus.

### BACKGROUND

In the related art, there has been proposed a scanner apparatus that recognizes the name of a commodity that is a target object on the basis of data on an image of the commodity that is picked up by using an image sensor such as a charge coupled device (CCD) and a complementary metal-oxide semiconductor (CMOS). Such a scanner apparatus recognizes the name of the target object in the following manner. Specifically, a feature amount of the target object is extracted from the picked-up image. Then, the extracted feature amount is compared with a feature amount for matching. The feature amount for matching is prepared in advance. In order to pick up an easily recognized image, an illuminance of the target object is ensured in such a manner that an illumination apparatus illuminates an inside of an image pickup region in which the image is picked up by the image sensor.

In general, such an illumination apparatus is provided within a casing together with an image pickup apparatus that captures image data. The casing includes a light-transmissive image pickup window. The image pickup window ensures a field of view for the image pickup apparatus. The image pickup window causes illumination light radiated from the illumination apparatus to transmit through the image pickup window and radiates the illumination light to the target object.

With such an illumination apparatus, an image picked up by the image pickup apparatus can include a highlight, so-called overexposure. The overexposure occurs in the case where light emitted from the illumination apparatus is reflected on the image pickup window and enters the image pickup apparatus. A ray that forms an unnecessary image like the overexposure is generally called stray light. The stray light is an obstacle to recognition processing when the image picked up by the image pickup apparatus is processed and the commodity is recognized. In view of this, there has been proposed an example in which a light-shielding region is provided in vicinity of illumination light sources in order to eliminate such stray light and reliably perform recognition processing. In accordance with such an example in the related art, it is necessary to provide a hood-like light shielding member in vicinity of the illumination apparatus. It is necessary to position the light shielding member in a manner that depends on a positional relationship between the illumination light sources and the image pickup apparatus. Therefore, when the arrangement of the illumination light sources is changed, the shape of the light shielding member has to be correspondingly changed. In other words, it is necessary to re-design the light shielding member in a manner that depends on the arrangement of the illumination light sources, which is troublesome. Therefore, it is desirable to realize a measure against the stray light, which enables the light shielding member to be easily re-designed even in the case where the arrangement of the illumination light sources is changed.

### BRIEF DESCRIPTION OF THE DRAWINGS

FIG. 1 is an external view showing a scanner apparatus according to an embodiment.

FIG. 2 is a side view of an image pickup device incorporated in the scanner apparatus.

FIG. 3A is a front view showing main parts of the image pickup device.

FIG. 3B is a front view showing a transmission plate of the image pickup device.

FIG. 4 is an explanatory diagram showing an installation position of a light shielding member.

FIG. 5A is an explanatory diagram showing behaviors of illumination light in a yz-plane at an outer edge portion of the light shielding member according to the embodiment.

FIG. 5B is an explanatory diagram showing behaviors of illumination light in the yz-plane at an outer edge portion of a light shielding member that is a comparison example.

FIG. 6A is an explanatory diagram showing behaviors of illumination light in an xy-plane at the outer edge portion of the light shielding member according to the embodiment.

FIG. 6B is an explanatory diagram showing behaviors of illumination light in the xy-plane at an outer edge portion of the light shielding member that is the comparison example.

FIG. 7A is an example of an image observed in the case where the light shielding member is not provided.

FIG. 7B is an example of an image when the light shielding member according to the embodiment is observed.

FIG. 7C is an example of an image when the light shielding member according to the comparison example is observed.

FIG. 7D is an example of an image observed when an adhesive protrudes from an outer edge of the light shielding member.

FIG. 8A is a cross-sectional view showing a state in which an adhesive does not protrude from the outer edge portion of the light shielding member and a front view of the light shielding member.

FIG. 8B is a cross-sectional view showing a state in which an adhesive protrudes from the outer edge portion of the light shielding member and a front view of the light shielding member.

### DETAILED DESCRIPTION

In accordance with an embodiment, a scanner apparatus includes a casing, an image pickup device, an illumination light source, a filter, and a light shielding member. The casing includes an image pickup window. The image pickup device is provided within the casing to pick up an image of an image pickup region outside the casing through the image pickup window. The illumination light source is provided within the casing to radiate illumination light toward the image pickup region. The filter is positioned approximately orthogonally to an optical axis of the image pickup device between the image pickup device and the image pickup window and light-transmissive. The light shielding member is provided on a surface of the filter to shield the illumination light. The light shielding member is positioned to prevent generation of stray light reflected inside the image pickup window and entering the image pickup device and stray light reflected on the surface of the filter and entering the image pickup device, the stray light being generated due to the illumination light.

Hereinafter, the scanner apparatus according to the embodiment will be further described with reference to the drawings. In the drawings, the same reference symbols represent the same or similar parts.

(Explanation of Configuration of Scanner Apparatus)

The scanner apparatus according to the embodiment utilizes a generic object recognition technology. The generic object recognition is a technology of recognizing the name, type, and the like of a commodity (object) that is a target on the basis of image data of that commodity that is captured by a camera. A computer extracts an appearance feature amount of the commodity included in the image data from the image data. Then, the computer matches the extracted appearance feature amount with feature amount data of a reference image registered in a recognition dictionary file to thereby determine a degree of similarity. The computer recognizes the name, type, and the like of that commodity on the basis of the degree of similarity. A technology of recognizing an item included in image data is explained in detail in Document below.

Keiji Yanai, “The Current State and Future Directions on Generic Object Recognition”, Journal of Information Processing Society of Japan, Vol. 48, No. SIG16 [searched on May 20, 2016], the Internet <URL: http://mm.cs.uec.ac.jp/IPSJ-TCVIM-Yanai.pdf>
In addition, a technology of performing generic object recognition by dividing image data into regions for each object is explained in detail in Document below.
Jamie Shotton, et al., “Semantic Texton Forests for Image Categorization and Segmentation”, [searched on May 20, 2016, 2016], the Internet <URL: http://jamie.shotton.org/work/publications/cvpr08.pdf#search=‘Jamie+Shotton+Semantic’>

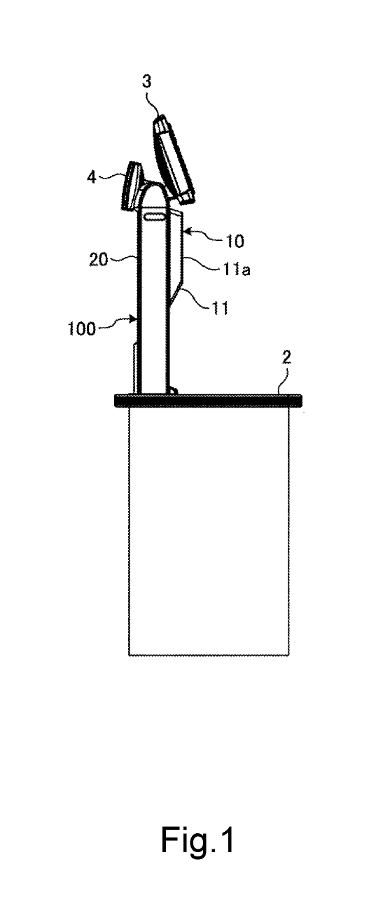

FIG. 1 is an external view showing an appearance of a scanner apparatus 100 according to the embodiment. As shown in FIG. 1, the scanner apparatus 100 is a vertical scanner apparatus and placed in a cashier of a store. The scanner apparatus 100 includes a casing 11 such that an image pickup window 11a is located at a height level lower than that of the eyes of an operator who faces the scanner apparatus 100. The casing 11 is provided above a sacker table 2. The casing 11 is formed in a box shape. Specifically, the box shape is a rectangular parallelepiped shape. The casing 11 includes the image pickup window 11a provided in a front wall of the casing 11. The casing 11 faces the operator when the operator is in front of the casing 11. The sacker table 2 is a table on which a shopping basket and the like are temporarily placed. The scanner apparatus 100 is provided with an operation device 3 and a display device 4 at an upper part of the scanner apparatus 100. The operation device 3 includes a display device with a touch panel, a keyboard, and the like. The operation device 3 receives operations of the operator who is an employee of the store. The display device 4 is provided, directed to customers. The display device 4 displays prices and the like of commodities.

The scanner apparatus 100 includes a scanner main body 10 and a support 20. The support 20 supports the scanner main body 10. The support 20 is provided upright on the sacker table 2. The scanner main body 10 is incorporated in the casing 11. The scanner main body 10 is mounted to an upper part of the support 20.

(Explanation of Configuration of Image Pickup Device)

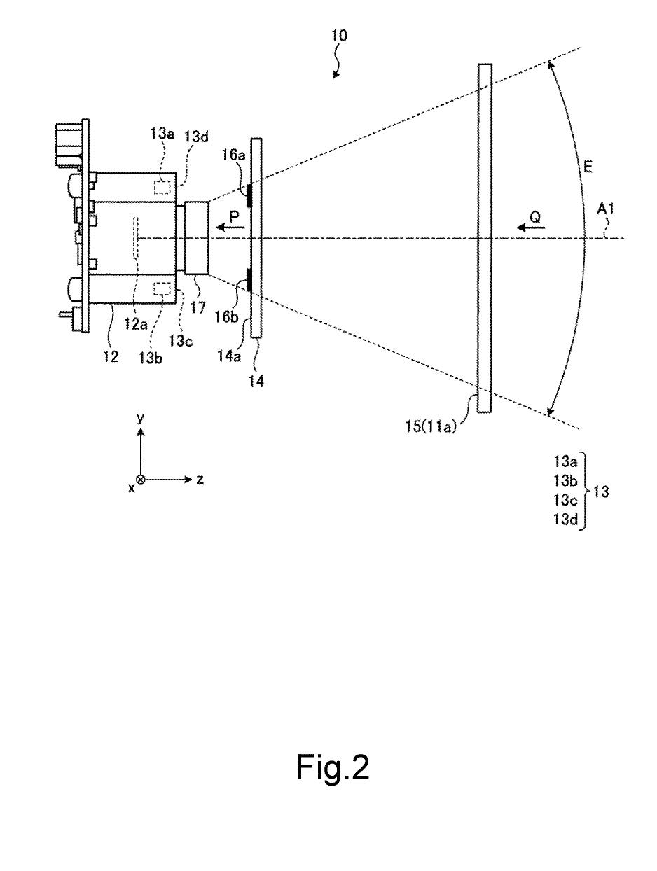

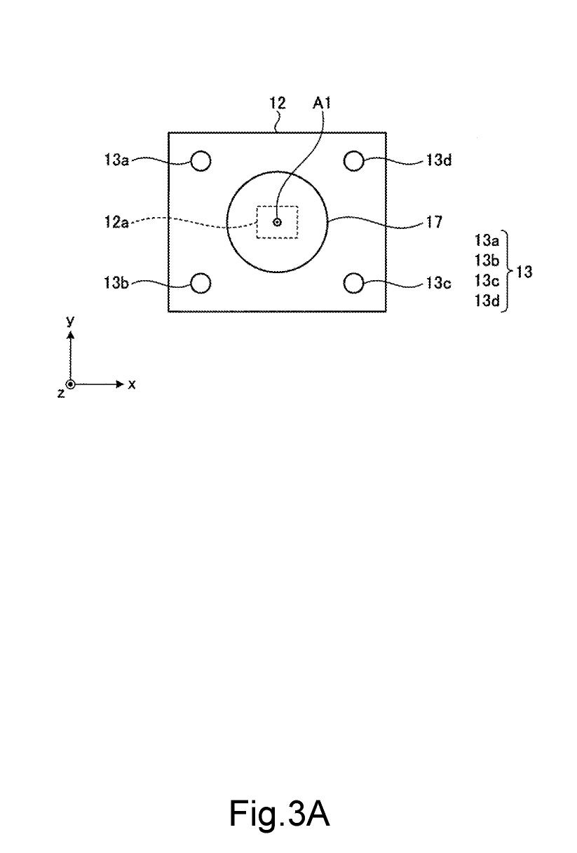

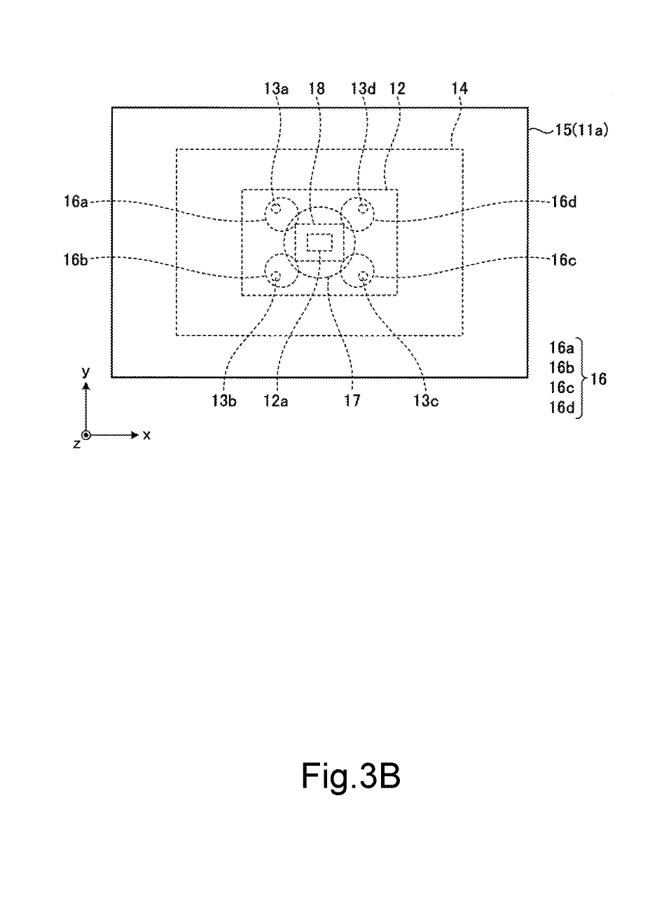

Hereinafter, a configuration of an image pickup device of the scanner main body 10 will be described with reference to FIGS. 2 and 3 in detail. FIG. 2 is a side view of the image pickup device 12 of the scanner main body 10 incorporated in the scanner apparatus 100. FIG. 3A is a front view of the image pickup device 12 (view as viewed in direction of arrow P of FIG. 2). FIG. 3B is a front view of a transmission plate 15 placed in the image pickup window 11a of the scanner apparatus 100 (view as viewed in direction of arrow Q of FIG. 2).

The scanner main body 10 includes the image pickup device 12, illumination light sources 13, and an image processing board (not shown) within the casing 11. The image pickup device 12 includes an image sensor 12a such as a CCD sensor and a CMOS sensor shown in FIG. 2. The illumination light sources 13 radiate illumination light toward an image pickup region E of the image pickup device 12. The image processing board processes image data of a commodity that is captured by the image sensor 12a. Specifically, the processing of the image processing board is associated with recognition of that commodity. The illumination light sources 13 are provided in vicinity of an outer circumference of an image pickup lens 17 of the image pickup device 12. The illumination light sources 13 include a plurality of white light emitting diodes (LEDs) 13a, 13b, 13c, 13d (installation positions of the LEDs 13c, 13d is shown in FIG. 3A in detail).

Note that a coordinate system xyz shown in FIG. 2 is defined for the following description. Specifically, coordinate axes x, y, and z are defined such that the coordinate axis x extends in a left and right direction (horizontal direction) of the image sensor 12a, the coordinate axis y extends in an upper and lower direction (vertical direction) of the image sensor 12a, and the coordinate axis z extends along an optical axis A1 of the image pickup lens 17.

As shown in FIG. 3B, the image pickup window 11a is formed in an approximately rectangular shape as viewed from the front.

The image pickup window 11a is formed of the transmission plate 15 which is transmissive and flat. The transmission plate 15 is made of transparent glass or resin, for example. An outer edge of the transmission plate 15 is supported by the casing 11 (FIG. 1). Specifically, the transmission plate 15 is fixed to the casing 11 with a fixing means such as an adhesive in a peripheral portion of the image pickup window 11a.

As shown in FIG. 3B, the image pickup device 12 is arranged at an approximately center position of the image pickup window 11a as the image pickup window 11a is viewed from the front. The image pickup lens 17 attached to the image pickup device 12 is provided such that the optical axis A1 is orthogonal to the transmission plate 15 at the approximately center position of the image pickup window 11a. The image pickup device 12 captures an appearance of a target object (commodity) held by the operator in the image pickup region E shown in FIG. 2 through the image pickup window 11a from an inside of the casing 11. The image pickup region E is formed outside the image pickup window 11a.

The image pickup device 12 outputs image data showing the captured appearance of the commodity. Then, the output image data is input into the above-mentioned image processing board (not shown). The image processing board performs generic object recognition processing of recognizing the name, type, and the like of that commodity on the basis of the image data. The generic object recognition processing is a well-known technology. Therefore, a detailed description of the generic object recognition processing will be omitted.

After the recognition of the name, type, and the like of the commodity shown in the image data is completed, the scanner apparatus 100 transmits the result of recognition to a point of sales (POS) terminal not shown in FIG. 1. Then, the POS terminal performs so-called sales data processing on the basis of the received result of recognition. The sales data processing includes finalization processing and settlement processing for commodities. Note that the contents of the sales data processing are well known and are not the summery of the embodiment, and hence a detailed description of the contents of the sales data processing will be omitted.

As shown in FIG. 3A, the illumination light sources 13 (white LEDs 13a, 13b, 13c, 13d) are provided in vicinity of the outer circumference of the image pickup lens 17 of the image pickup device 12. The illumination light sources 13 are provided in a region outside the image pickup region E and radiates illumination light to the image pickup region E. In order to illuminate an inside of the image pickup region E as evenly as possible, the four white LEDs (13a, 13b, 13c, 13d) are located at positions symmetric with respect to the optical axis A1 of the image pickup lens 17. Further, optical axes of the white LEDs (13a, 13b, 13c, 13d) are arranged approximately in parallel with one another. Note that, although the illumination light sources 13 include the four white LEDs (13a, 13b, 13c, 13d) in the embodiment, the number of LEDs is not limited to four.

Illumination light radiated from the illumination light sources 13 is reflected on the target object (commodity) located in the image pickup region E outside the image pickup window 11a. The reflected illumination light enters the casing 11 through the image pickup window 11a. An image of the entering illumination light is picked up by the image sensor 12a through the image pickup lens 17.

An image pickup allowable range of the image sensor 12a in the image pickup device 12 depends on characteristics of the image pickup lens 17. The image pickup lens 17 of the embodiment is a fixed focus lens. A focal position (best focus position) is a position spaced away from a tip end of the image pickup lens 17 by a certain distance. In the case where a commodity that is an image pickup object is placed at that focal position, a clear image having highest resolution is picked up. As the commodity that is the image pickup object is placed at a position nearer to the image sensor 12a or at a position farther to the image sensor 12a from the focal position, an unfocused image having lower resolution is picked up.

As shown in FIG. 3B, a rectangular filter 14 is provided between the image pickup lens 17 and the transmission plate such that the filter 14 is positioned approximately orthogonally to the optical axis A1 of the image pickup lens 17 (FIG. 2). The filter 14 is formed of transparent, light-transmissive resin, for example, polycarbonate. Light shielding members 16 (16a, 16b, 16c, 16d) are positioned corresponding to the white LEDs (13a, 13b, 13c, 13d) that constitute the illumination light sources 13 on a surface 14a (FIG. 2) of the filter 14 on a side of the image pickup device 12. That is, the filter 14 is a translucent member that causes light to transmit through the filter 14 when the image sensor 12a picks up an image in the image pickup region E through the image pickup lens 17. The filter 14 is also a support member for the light shielding members 16. Note that the installation positions and shapes of the light shielding members 16 (16a, 16b, 16c, 16d) will be described later in detail.

The light shielding members 16 (16a, 16b, 16c, 16d) are black seals having light-shielding properties. The light shielding members 16 (16a, 16b, 16c, 16d) are molded by die cutting with a press cutter, a laser cutter, or the like. The light shielding members 16 (16a, 16b, 16c, 16d) are bonded to the surface 14a of the filter 14 on the side of the image pickup device 12 with an adhesive.

Note that a hole 18 is formed at a center portion of the filter 14 as shown in FIG. 3B. The hole 18 is provided in order to enable the image sensor 12a to pick up an image of a commodity that is a target object held outside the image pickup window 11a as clearly as possible.

(Explanation of Installation Position of Light Shielding Member)

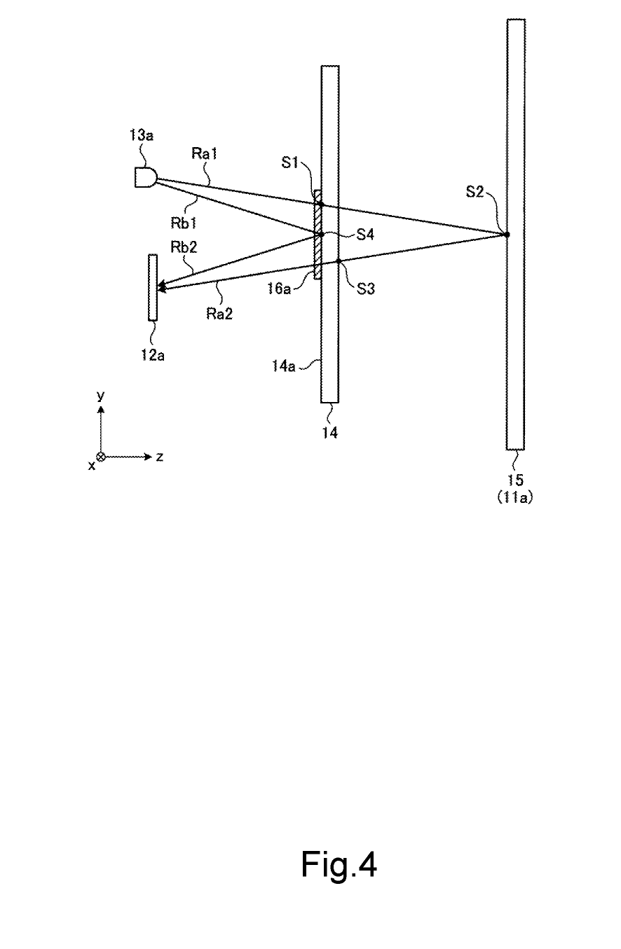

Next, the installation positions of the light shielding members 16 will be described with reference to FIG. 4. Note that only a light shielding member 16a of the plurality of light shielding members 16 (16a, 16b, 16c, 16d) (FIG. 3B) described above will be described and the light shielding member 16a shields illumination light emitted from the white LED 13a.

A ray Ra1 of illumination light emitted from the white LED 13a enters the filter 14 at a point S1. Then, the ray Ra1 transmits through the filter 14 and reaches a point S2 of the transmission plate 15 (image pickup window 11a). The ray Ra1 is specularly reflected at the point S2 and reaches a point S3 of the filter 14 as a ray Ra2. Then, the ray Ra2 transmits through the filter 14 and is observed by the image sensor 12a as stray light. At this time, the light shielding member 16a is positioned such that the light shielding member 16a shields the ray Ra1 entering the point S1 or the ray Ra2 entering the point S3. Therefore, the image sensor 12a does not observe the ray Ra2. In other words, no stray light is generated. Note that the light shielding member 16a is positioned such that the light shielding member 16a shields the ray Ra1 reaching the point S1 and the ray Ra2 reaching the point S3 in FIG. 4. However, the light shielding member 16a only has to be positioned such that the light shielding member 16a can shield either the ray Ra1 reaching the point S1 or the ray Ra2 reaching the point S3.

Further, as shown in FIG. 4, a ray Rb1 of illumination light emitted from the white LED 13a enters the filter 14 at a point S4. Then, the ray Rb1 is specularly reflected at the point S4 and observed by the image sensor 12a as a ray Rb2. The ray Rb2 is also observed by the image sensor 12a as stray light. At this time, the light shielding member 16a is positioned such that the light shielding member 16a shields the ray Rb1 entering the point S4. Therefore, the image sensor 12a does not observe the ray Rb2. In other words, no stray light is generated.

A condition that a ray emitted from the white LED 13a and reaching the filter 14 or the transmission plate 15 is specularly reflected and does not enter the image sensor 12a can be calculated in advance on the basis of the position of the white LED 13a, the position of the image sensor 12a, the position of the filter 14, and the position of the transmission plate 15. Therefore, if the lay-out of the scanner main body 10 is only fixed, the size and the shape of the installation position of the light shielding member 16a can be designed in advance under a condition that no stray light is generated.

(Explanation of Behaviors of Illumination Light Reaching Light Shielding Member (Direction Orthogonal to Filter))

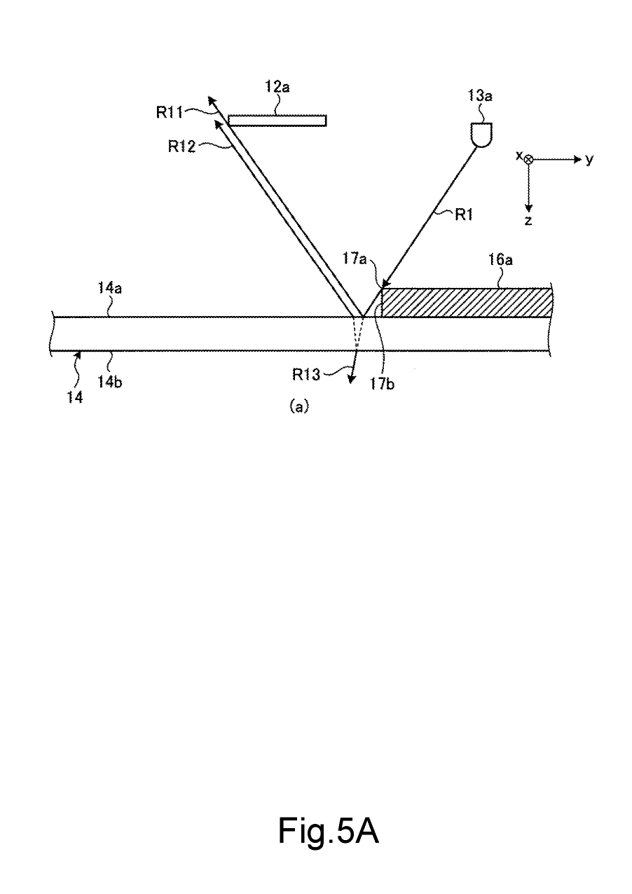

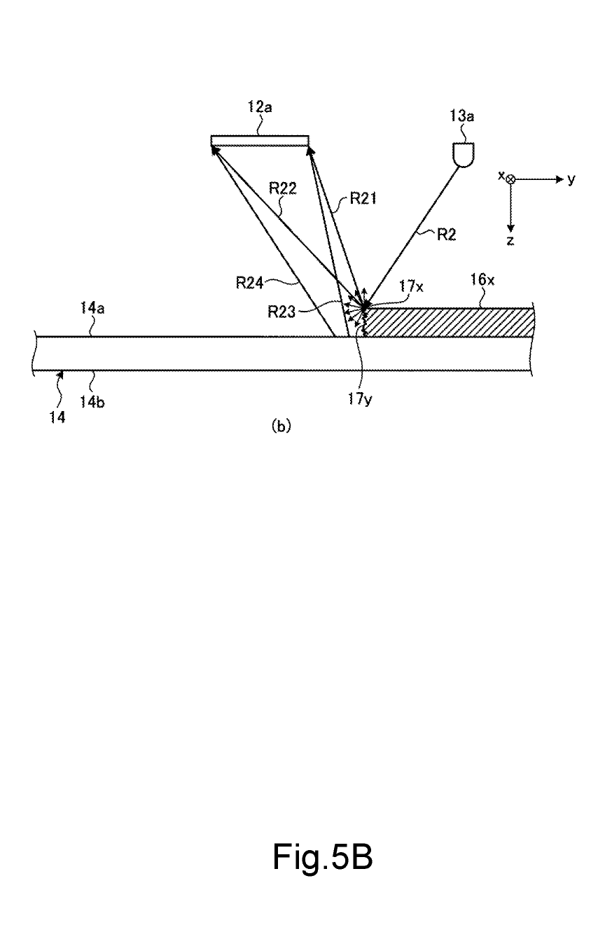

Next, behaviors of illumination light emitted from the illumination light source 13 and reaching the light shielding member 16 in the scanner apparatus 100 will be described with reference to FIGS. 5A and 5B. FIGS. 5A and 5B are explanatory diagrams showing behaviors of illumination light in the yz-plane. Note that illumination light emitted from any of the white LEDs (13a, 13b, 13c, 13d) exhibits similar behaviors when that illumination light reaches any of the light shielding members 16 (16a, 16b, 16c, 16d) positioned corresponding to the white LEDs (13a, 13b, 13c, 13d), respectively. Behaviors when the illumination light emitted from the white LED 13a reaches the light shielding member 16a will be described here as a representative.

FIG. 5A is an explanatory diagram showing behaviors of the illumination light emitted from the white LED 13a in the yz-plane at an outer edge portion 17a of the light shielding member 16a. The light shielding member 16a is formed with a die-cut seal.

A ray of illumination light emitted from the white LED 13a and illumination light reaching the light shielding member 16a, which has reached a surface of the light shielding member 16a, is shielded. Therefore, the ray reaching the surface of the light shielding member 16a does not arrive at the image pickup region E (FIG. 2) on a side of a back surface 14b of the filter 14. On the other hand, a part of a ray reaching an outside of the outer edge portion 17a of the light shielding member 16a, for example, a ray R1 shown in FIG. 5A transmits through the filter 14 and arrives at the image pickup region E as a ray R13, for example.

Further, a part of the ray R1 is specularly reflected on the surface 14a of the filter 14 and travels in the direction of the image sensor 12a as a ray R11. If the ray R11 reaches the image sensor 12a, a bright image due to the ray R11 is formed in the image sensor 12a. In this case, the ray R11 becomes so-called stray light.

Note that, although a part of the ray R1 reaching the surface 14a of the filter 14 is refracted and arrives at the back surface 14b of the filter 14, a part of the ray reaching the back surface 14b is specularly reflected on the back surface 14b of the filter 14. Then, the specularly reflected part of the ray travels in the direction of the image sensor 12a as a ray R12. If the ray R12 arrives at the image sensor 12a, a bright image due to the ray R12 is formed in the image sensor 12a. That is, the ray R12 similarly becomes stray light.

The light shielding member 16a is positioned to prevent generation of such stray light. Therefore, when the illumination light emitted from the white LED 13a is specularly reflected on the surface 14a and the back surface 14b of the filter 14, the specularly reflected light becomes the stray light and is not observed by the image sensor 12a.

Note that, due to the provision of the light shielding member 16a, the stray light can be prevented while part of the illumination light emitted from the white LED 13a is shielded by the light shielding member 16a, and hence the amount of light that illuminates the commodity that is the image pickup object is reduced in the image pickup region E. Therefore, the reduced amount of light can be compensated for by providing the plurality of white LEDs (13a, 13b, 13c, 13d) as the illumination light sources 13. Further, although not shown in the figure, the decrease of the amount of light may be compensated for by providing another white LED that illuminates the inside of the image pickup region E in addition to the white LEDs (13a, 13b, 13c, 13d).

Next, behaviors of the ray of the illumination light emitted from the white LED 13a, which has reached the outer edge portion 17a of the light shielding member 16a, will be described. A part of the ray R1 reaching the outer edge portion 17a is diffracted at the outer edge portion 17a and turns to a marginal region 17b that is an outer circumferential surface formed in a thickness direction of the light shielding member 16a. Then, the ray R1 turning to the marginal region 17b exhibits a reflection characteristic depending on a state of the surface forming the marginal region 17b.

The light shielding member 16a used in the embodiment is molded by die cutting with a press cutter, a laser cutter, or the like. Therefore, the marginal region 17b forming the outer circumferential surface of the light shielding member 16a has few minute irregularities and forms a smooth surface with respect to which a normal direction is continuous in an outer circumferential direction and the thickness direction of the light shielding member 16a. That is, the surface formed by the marginal region 17b is close to a smooth surface. Therefore, the ray R1 turning to the marginal region 17b due to the diffraction exhibits a behavior having a high specular reflection characteristic. That is, a large part of the ray R1 reaching the marginal region 17b of the light shielding member 16a is specularly reflected and reaches the surface 14a or the back surface 14b of the filter 14. Then, the ray R1 is refracted on the surface 14a or the back surface 14b of the filter 14 and travels toward the image pickup region E. Or, the ray R1 is specularly reflected on the surface 14a or the back surface 14b of the filter 14 and travels toward the image pickup device 12.

In the embodiment, the installation position, size, and shape of the light shielding member 16a are designed such that also the specularly reflected light of the ray R1 reaching the marginal region 17b does not enter the image sensor 12a. Therefore, the light shielding member 16a prevents the ray R1 reaching the marginal region 17b from becoming the stray light. Note that a part of the ray R1 reaching the outer edge portion 17a and the marginal region 17b undergoes diffuse reflection (irregular reflection). However, the surface that constitutes the outer edge portion 17a and the marginal region 17b is close to the smooth surface, and hence diffusely reflected light is little. Therefore, an image of the light shielding member 16a that is picked up by the image sensor 12a does not become an image in which the outer edge portion 17a and the marginal region 17b brightly light due to the stray light. The same applies to other light shielding members 16b, 16c, 16d.

Next, behaviors of illumination light in the case where a light shielding member 16x formed by printing such as silk printing is provided on the surface 14a of the filter 14 will be described as a comparison example with reference to FIG. 5B. FIG. 5B is a diagram describing behaviors of illumination light in an outer edge portion 17x and a marginal region 17y of the light shielding member 16x formed by printing.

As in the above-mentioned light shielding member 16a, the light shielding member 16x shields the ray reaching the light shielding member 16x to thereby prevent generation of the stray light due to the specularly reflected light on the surface 14a or the back surface 14b of the filter 14. Note that the light shielding member 16x formed by printing is formed with ink flowing out through a screen formed of a mesh of cloth or the like, and hence a surface that constitutes the outer edge portion 17x and the marginal region 17y of the light shielding member 16x generally forms a rough surface having minute, random irregularities. That is, the outer circumferential surface of the light shielding member 16x becomes a surface with respect to which the normal direction is discontinuous in the outer circumferential direction and the thickness direction.

In FIG. 5B, a part of the ray R2 that is the illumination light emitted from the white LED 13a reaches the outer edge portion 17x and then is diffracted at the outer edge portion 17x and turns to the marginal region 17y. Then, a part of the ray R2 undergoes diffuse reflection (irregular reflection) in the outer edge portion 17x and the marginal region 17y. At this time, points of the outer edge portion 17x and the marginal region 17y at which the diffuse reflection occurs radiate light in all directions as if point light sources were present at those points. Then, the diffusely reflected light of the diffusely reflected rays, which travels between a ray R21 and a ray R22 shown in FIG. 5B, for example, reaches the image sensor 12a. In other words, the image sensor 12a observes the stray light.

Further, a ray of the rays diffusely reflected at the outer edge portion 17x, which has reached the back surface 14b of the filter 14, is specularly reflected on the back surface 14b and travels in the direction of the image sensor 12a. Then, the specularly reflected light traveling between a ray R23 and a ray R24 shown in FIG. 5B, for example, reaches the image sensor 12a. In other words, the image sensor 12a observes the stray light.

In addition, a part of the ray R2 is diffracted at the outer edge portion 17x and reaches the marginal region 17y. The surface constituting the marginal region 17y also forms a diffuse reflection surface, and the diffusely reflected light in the marginal region 17y reaches the image sensor 12a. In other words, the image sensor 12a observes the stray light.

A large part of the ray R2 reaching the outer edge portion 17x and the marginal region 17y of the light shielding member 16x undergoes diffuse reflection (irregular reflection) and takes the above-mentioned behaviors. Therefore, the image pickup device 12 observes an image as if numerous point light sources were present in the outer edge portion 17x and the marginal region 17y that form the outer circumferential surface of the light shielding member 16x.

Such diffuse reflection occurs at all points of the outer edge portion 17x and the marginal region 17y that form the outer circumferential surface of the light shielding member 16x, which the illumination light emitted from the white LED 13a reaches. Therefore, in the example of FIG. 5B, the image pickup device 12 observes an image in which the outer edge portion 17x and the marginal region 17y of the light shielding member 16x light. In addition, as described above, the specularly reflected light on the back surface 14b of the filter 14 is also observed at the same time. Therefore, the image pickup device 12 observes a double contour along the outer edge portion 17x of the light shielding member 16x. An actual example of an actually observed image will be described later.

(Explanation of Behaviors of Illumination Light Reaching Light Shielding Member (Plane Direction of Filter))

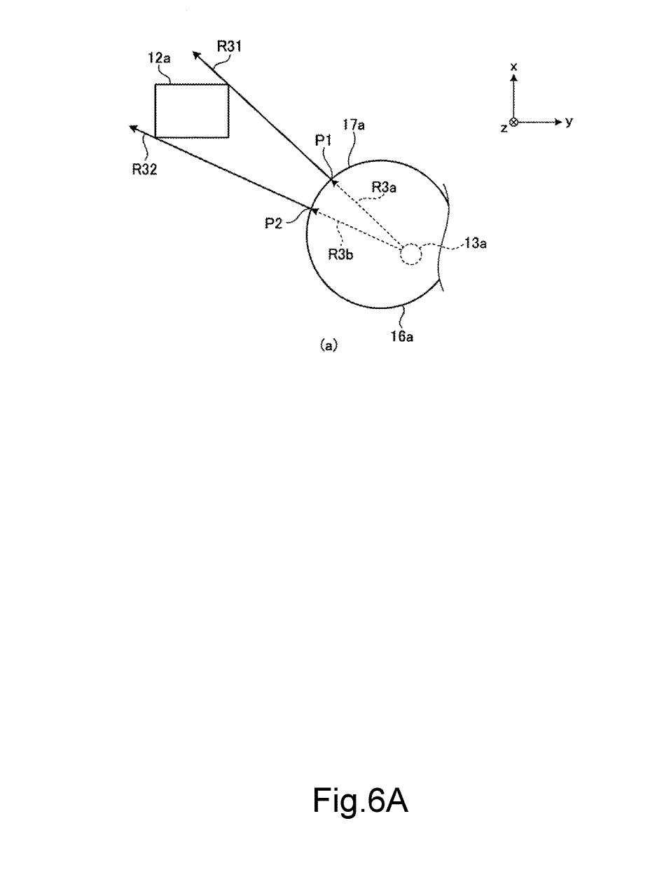

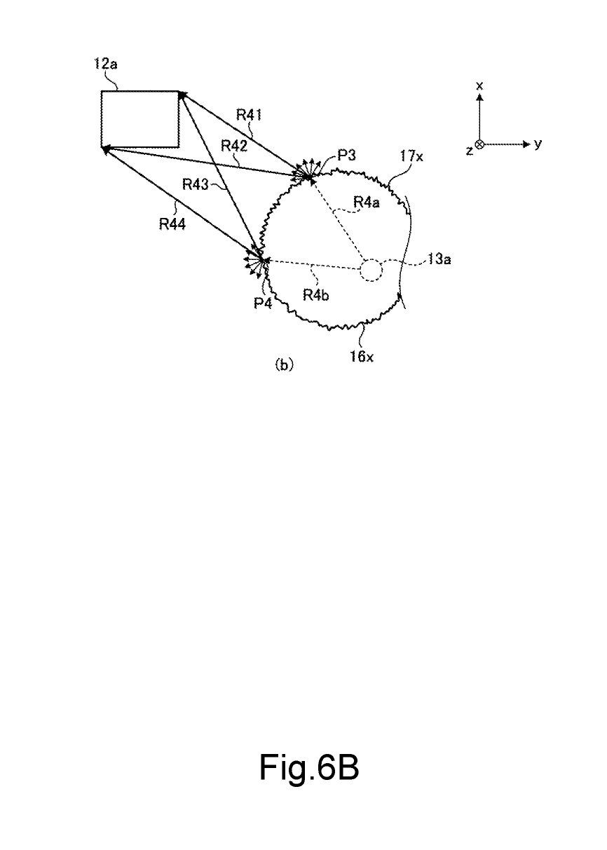

Next, behaviors of illumination light emitted from the illumination light source 13 and reaching the light shielding member 16 in the scanner apparatus 100 will be described with reference to FIGS. 6A and 6B. FIGS. 6A and 6B are explanatory diagrams showing behaviors of illumination light in an xy-plane. Note that illumination light emitted from any of the white LEDs (13a, 13b, 13c, 13d) exhibits similar behaviors when reaching the light shielding members 16 (16a, 16b, 16c, 16d) positioned corresponding to those white LEDs (13a, 13b, 13c, 13d). Here, behaviors when the illumination light emitted from the white LED 13a reaches the light shielding member 16a will be described as a representative.

FIG. 6A is an explanatory diagram showing behaviors of the illumination light emitted from the white LED 13a in the xy-plane at the outer edge portion 17a of the light shielding member 16a. The light shielding member 16a is formed with a die-cut seal.

A ray of illumination light emitted from the white LED 13a and reaching the light shielding member 16a, which has reached the surface of the light shielding member 16a is shielded. Therefore, such a ray does not arrive at the image pickup region E (FIG. 2) on the side of the back surface 14b of the filter 14 as viewed from the image sensor 12a. On the other hand, a ray reaching an outside of the outer edge portion 17a of the light shielding member 16a, for example, parts of the rays R3a, R3b shown in FIG. 6A are specularly reflected at points P1, P2 on the surface 14a of the filter 14 (FIG. 5A) and travel in the direction of the image sensor 12a as rays R31, R32. When the rays R31, R32 arrive at the image sensor 12a, bright images due to the rays R31, R32 are formed in the image sensor 12a. That is, the rays R31, R32 become so-called stray light. However, as described above, the light shielding member 16a is positioned to prevent generation of such stray light. Therefore, the rays R31, R32 are not observed by the image sensor 12a.

Parts of the rays R3a, R3b are diffracted at the outer edge portion 17a and go around into the marginal region 17b (FIG. 5A). A surface constituting the marginal region 17b is close to the smooth surface. Therefore, the ray turning to the marginal region 17b due to the diffraction is specularly reflected on the surface constituting the marginal region 17b. Then, the specularly reflected light is further specularly reflected on the surface 14a and the back surface 14b of the filter 14 and travels in the direction of the image sensor 12a. The size and the shape of the installation position of the light shielding member 16a are determined such that any of those specularly reflected light beams do not arrive at the image sensor 12a. That is, the image sensor 12a does not observe the stray light.

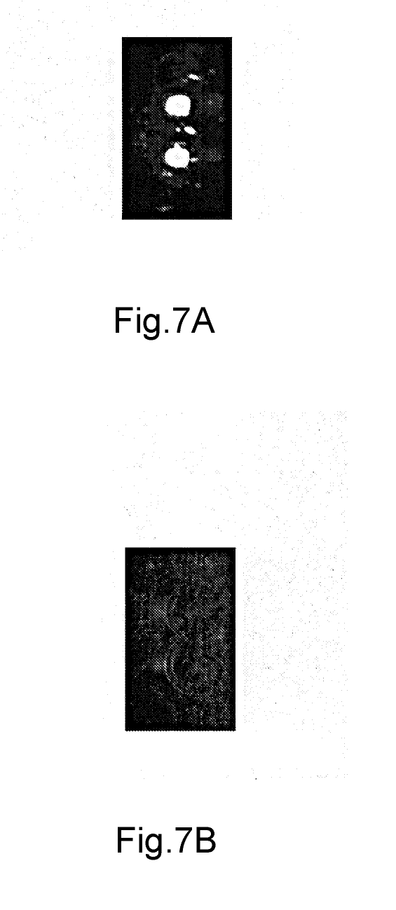

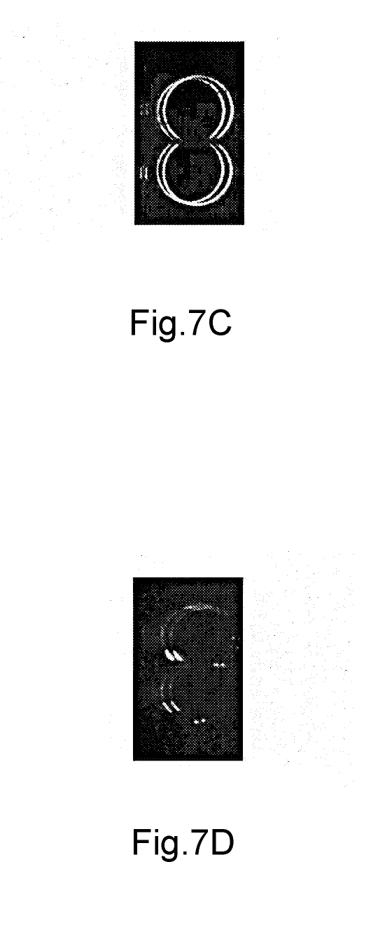

FIG. 7B is an example of an image including the light shielding member 16a that is actually observed by the image pickup device 12 under the condition shown in FIGS. 5A and 6A. As shown in FIG. 7B, it can be seen that a specularly reflected image (see FIG. 7A) of the white LED 13a that is observed in the case where the light shielding member 16a is not provided is not observed due to the provision of the light shielding member 16a. That is, the recognition is not interfered with when the scanner apparatus 100 performs processing of recognizing an image of a commodity that is an image pickup target.

Next, behaviors of illumination light in the case where the light shielding member 16x formed by printing such as silk printing is provided on the surface 14a of the filter 14 will be described as a comparison example with reference to FIG. 6B. FIG. 6B is a diagram describing behaviors of illumination light in the outer edge portion 17x and the marginal region 17y of the light shielding member 16x (FIG. 5B) formed by printing.

The surface that constitutes the outer edge portion 17x of the light shielding member 16x forms a rough surface having minute, random irregularities as described above. That is, the surface that constitutes the outer edge portion 17x of the light shielding member 16x forms a surface with respect to which the normal direction is discontinuous in the outer circumferential direction of the light shielding member 16x. Therefore, a ray emitted from the white LED 13a and reaching the outer edge portion 17x, for example, parts of rays R4a, R4b undergoes diffuse reflection (irregular reflection) at the outer edge portion 17x. At this time, points P3, P4 of the outer edge portion 17x at which the diffuse reflection occurs diffusely reflect light in all directions as if point light sources were present at the points P3, P4. At this time, diffusely reflected light of the ray diffusely reflected at the point P3, which travels between a ray R41 and a ray R42, for example, reaches the image sensor 12a. In other words, the image sensor 12a observes the stray light. Similarly, the diffusely reflected light of the ray diffusely reflected at the point P4, which travels between a ray R43 and a ray R44, for example, reaches the image sensor 12a. In other words, the image sensor 12a observes the stray light.

In addition, a part of the ray reaching the outer edge portion 17x turns to the marginal region 17y (FIG. 5B) due to diffraction. Then, the ray turning to the marginal region 17y undergoes diffuse reflection in the marginal region 17y. Then, a part of the ray diffusely reflected and reaches the image sensor 12a. Therefore, the image sensor 12a observes the stray light.

Such diffuse reflection occurs at all points of the outer edge portion 17x and the marginal region 17y that form the outer circumferential surface of the light shielding member 16x, which the illumination light emitted from the white LED 13a reaches. Therefore, in the example of FIG. 6B, the image pickup device 12 observes an image in which the outer edge portion 17x and the marginal region 17y of the light shielding member 16x light. In addition, as described above, the specularly reflected light on the back surface 14b of the filter 14 is also observed at the same time. Therefore, the image pickup device 12 observes a double contour along the outer edge portion 17x of the light shielding member 16x. The actual example of the actually observed image will be described later.

FIG. 7C is an example of an image including the light shielding member 16x actually observed by the image pickup device 12 under the condition shown in FIGS. 5B and 6B. The double contour shown in FIG. 7C corresponds to a ray generated due to the diffusely reflected light at the outer edge portion 17x and the marginal region 17y of the light shielding member 16x and a ray generated due to specular reflection of the diffusely reflected light on the back surface 14b of the filter 14. The double contour becomes noise that interferes with recognition when the scanner apparatus 100 performs processing of recognizing the image of the commodity that is the image pickup target. Therefore, it is desirable that generation of the double contour can be prevented as in FIG. 7B described above.

(Explanation of Bonding Method for Light Shielding Member)

In the embodiment, the light shielding members 16 (16a, 16b, 16c, 16d) are bonded to the surface 14a of the filter 14 with an adhesive 19. The adhesive 19 is an example of the adhesive member in the embodiment.

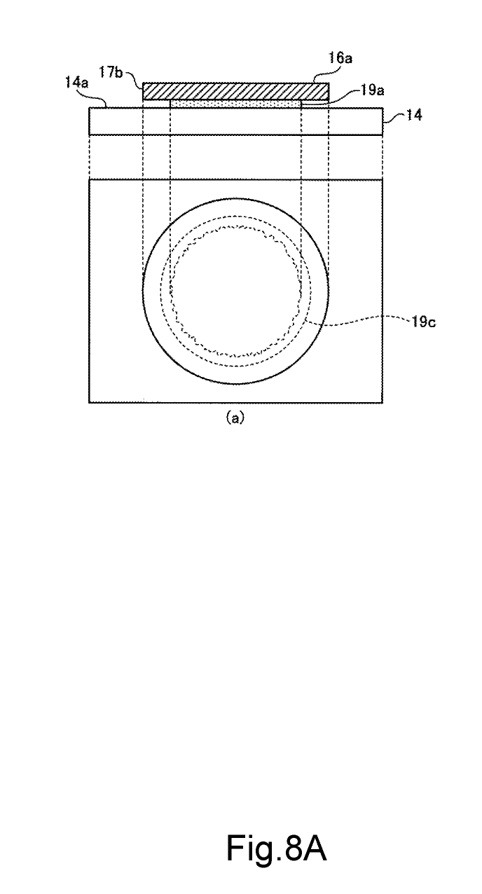

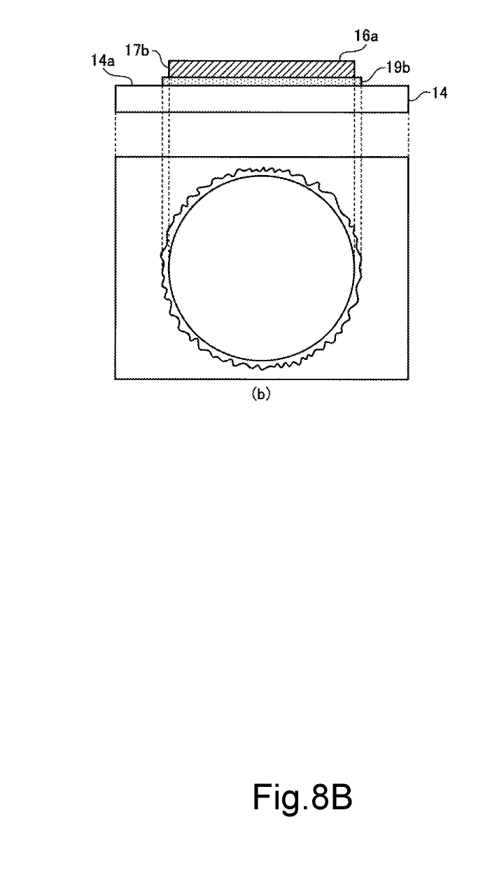

A bonding structure for the light shielding member 16a will be described with reference to FIGS. 8A and 8B. FIG. 8A is a diagram showing a bonding structure of the light shielding member 16a. As shown in FIG. 8A, the light shielding member 16a is bonded to the surface 14a of the filter 14 with an adhesive 19a applied to the back surface of the light shielding member 16a. At this time, the adhesive 19a is applied only to an inside of a bond margin 19c. The bond margin 19c is located inwardly away from the marginal region 17b of the light shielding member 16a by a predetermined amount. Then, when the light shielding member 16a is bonded to the surface 14a of the filter 14, the press-fixed adhesive 19a does not protrude beyond the bond margin 19c to the outside. That is, in this case, illumination light emitted from the white LED 13a (FIG. 2) that constitutes the illumination light sources 13 is not radiated to the adhesive 19a. Therefore, the adhesive 19a does not affect behaviors of illumination light.

Note that a predetermined amount to define the installation position of the above-mentioned bond margin 19c can be determined in advance on the basis of the amount of adhesive 19a to be applied, the viscosity of the adhesive 19a, press-fixing force when the light shielding member 16a is press-fixed to the filter 14, and the like. As an example, the light shielding member 16a having a diameter of 8 mm is provided with the bond margin 19c shifted from the outer circumference by 0.5 mm, for example.

Next, a case where an adhesive 19b protrudes from the marginal region 17b of the light shielding member 16a will be described as a comparison example with reference to FIG. 8B. In the example of FIG. 8B, the adhesive 19b is applied to the entire back surface of the light shielding member 16a. Then, the press-fixed adhesive 19b protrudes from the marginal region 17b to the outside of the light shielding member 16a when the light shielding member 16a is bonded to the surface 14a of the filter 14. In the case where the adhesive 19b protrudes in this manner, the illumination light emitted from the white LED 13a that constitutes the illumination light sources 13 is radiated to the adhesive 19b protruding from the marginal region 17b. The illumination light radiated to the adhesive 19b is specularly reflected or diffusely reflected on the surface of the adhesive 19b. Therefore, the reflection light from the adhesive 19b is observed in the image of the light shielding member 16a observed by the image pickup device 12. The reflection light from the adhesive 19b becomes noise when the image pickup device 12 performs processing of recognizing the image of the commodity that is the image pickup target. Therefore, such reflection light is an obstacle to the recognition processing of the scanner apparatus 100.

FIG. 7B is a diagram showing an example of an image obtained by capturing reflection light from the protruding adhesive 19b, which is observed by the image pickup device 12. As shown in FIG. 7D, the reflection light from the protruding adhesive 19b is observed as the stray light.

Note that, although the adhesive 19a does not protrude to the outside of the bond margin 19c when the light shielding member 16a is press-fixed to the filter 14 in the embodiment, even if the adhesive 19a protrudes to the outside of the bond margin 19c, the adhesive 19a does not affect behaviors of illumination light as long as the adhesive 19a does not protrude from the outer circumference of the light shielding member 16a.

As described above, in accordance with the scanner apparatus 100 of the embodiment, the illumination light source 13 radiates illumination light from the side of the image pickup device 12 toward the image pickup region E of the image pickup device 12. Then, part of the radiated illumination light is shielded by the light shielding member 16 including the marginal region 17b (outer circumferential surface) provided in the plane of the light-transmissive filter 14 positioned approximately orthogonally to the optical axis A1 of the image pickup device 12 between the illumination light source 13 and the image pickup region E. The light shielding member 16 is positioned to prevent generation of the stray light reflected inside the image pickup window 11a and entering the image pickup device 12 and the stray light reflected on the surface of the filter 14 and entering the image pickup device 12, the stray light being generated due to illumination light. Therefore, generation of the stray light can be prevented with a simple configuration.

Further, in accordance with the scanner apparatus 100 of the embodiment, regarding the marginal region 17b (outer circumferential surface) of the light shielding members 16 (16a, 16b, 16c, 16d), the normal direction in the marginal region 17b is continuous in the outer circumferential direction of the light shielding member 16 and the thickness direction of the light shielding member 16. Therefore, illumination light reaching the marginal region 17b exhibits a high specular reflection characteristic. Therefore, it is possible to determine a traveling direction of reflection light by calculation in advance. That is, it is possible to calculate the installation position and the size and the shape of the light shielding member in advance, with which the stray light can be reliably prevented.

Then, in accordance with the scanner apparatus 100 of the embodiment, the light shielding member 16 (16a, 16b, 16c, 16d) is bonded to a surface (surface 14a) of the filter 14 on the side of the image pickup device 12 with the adhesive 19a (adhesive member). Therefore, it is possible to reliably prevent both of the stray light reflected inside the image pickup window 11a and entering the image pickup device 12 and the stray light reflected on the surface of the filter 14 and entering the image pickup device 12, the stray light being generated due to illumination light.

In addition, in accordance with the scanner apparatus 100 of the embodiment, the adhesive 19a (adhesive member) is applied to the range located inwardly away from the outer edge of the light shielding member 16 (16a, 16b, 16c, 16d) by a predetermined amount. Therefore, when the light shielding member 16 (16a, 16b, 16c, 16d) is bonded to the filter 14, the adhesive 19a does not protrude from the outer circumference of the light shielding member 16. Therefore, the adhesive 19a does not affect behaviors of illumination light.

Further, in accordance with the scanner apparatus 100 of the embodiment, the filter 14 includes the hole 18 in a part of the image pickup region E of the image pickup device 12. Therefore, the image sensor 12a can clearly image the commodity that is the target object held outside the image pickup window 11a.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A scanner apparatus, comprising:
a casing including an image pickup window;
an image pickup device provided within the casing to pick up an image of an image pickup region outside the casing through the image pickup window;
an illumination light source provided within the casing to radiate illumination light toward the image pickup region;
a light-transmissive filter positioned approximately orthogonally to an optical axis of the image pickup device between the image pickup device and the image pickup window; and
a light shielding member provided on a surface of the filter to shield the illumination light, the light shielding member being positioned to prevent generation of stray light reflected inside the image pickup window and entering the image pickup device and stray light reflected on the surface of the filter and entering the image pickup device, the stray light being generated due to the illumination light.

2. The scanner apparatus according to claim 1, wherein
the light shielding member includes an outer circumferential surface with respect to which a normal direction is continuous in an outer circumferential direction of the light shielding member and a thickness direction of the light shielding member.

3. The scanner apparatus according to claim 1, wherein
the light shielding member is provided on a surface of the filter on a side of the image pickup device.

4. The scanner apparatus according to claim 3, wherein
the light shielding member is bonded to the surface of the filter on the side of the image pickup device with an adhesive member.

5. The scanner apparatus according to claim 4, wherein
the adhesive member is applied in a range of the light shielding member, the range being located inwardly away from the outer circumferential surface by a predetermined amount.

6. The scanner apparatus according to claim 5, wherein
the range of the light shielding member is such a range that the applied adhesive member is prevented from influencing a behavior of the illumination light.

7. The scanner apparatus according to claim 1, wherein
the filter includes a hole in a part of the image pickup region of the image pickup device.

8. The scanner apparatus according to claim 1, wherein
the image pickup window includes a flat transmission plate,
the image pickup device includes an image pickup lens arranged such that the optical axis is orthogonal to the transmission plate at an approximately center position of the image pickup window, and
the illumination light source includes a plurality of illumination light sources in vicinity of an outer circumference of the image pickup lens.

9. The scanner apparatus according to claim 8, wherein
the filter is positioned approximately orthogonally to the optical axis of the image pickup lens between the image pickup lens and the transmission plate.

10. The scanner apparatus according to claim 8, wherein
the light shielding member includes a plurality of light shielding members positioned respectively corresponding to the plurality of illumination light sources on the surface of the filter on the side of the image pickup device.
